(19) United States
(12) Patent Application Publication
(10) Pub. No.: US 2008/0092553 A1
(43) Pub. Date: Apr. 24, 2008

(54) Device for the Refrigerated Storage and Delivery of Samples and an Integrated Liquid Cooling Unit That is Suitable Therefor

(76) Inventors: Hermann Hochgraeber, Offenburg-Neuhausen (DE); Adolf Satzinger, Olching (DE); Gerhard Martens, Munchen (DE)

Correspondence Address: MORGAN, LEWIS & BOCKIUS, LLP, ONE MARKET SPEAR STREET TOWER, SAN FRANCISCO, CA, 94105, US

(21) Appl. No.: 11/573,083

(22) PCT Filed: Jul. 18, 2005
(86) PCT No.: PCT/DE05/01264

§ 371 Date: Feb. 1, 2007

(30) Foreign Application Priority Data
Aug. 2, 2004 (DE) 102004037341.8

(51) Int. Cl. F25B 21/02; G01N 30/00

(52) U.S. Cl. 62/3.6

(57) ABSTRACT

The invention relates to a device for the refrigerated storage and dispensing of substance samples, in particular a sample dispenser that is used in chromatography. Said device comprises a holder (7) for receiving one or more substance samples (3), at least one section of the holder (7) comprising at least one cavity (13) that is traversed by a liquid coolant (29), said cavity or cavities (13) being connected to a feed connection for supplying the coolant (29) and a return connection for evacuating the coolant (29). The device also comprises a liquid refrigeration unit (21), the feed connection of which is connected to the feed connection of the cavity or cavities (13) and the return connection of which is connected to the return connection of the cavity or cavities (13), a pump (23) for transporting the coolant (29) through the cavity or cavities (13) and a Peltier refrigeration unit (27) for cooling the coolant (29). In addition, the invention relates to an integrated liquid refrigeration unit (21) for a device of this type.

The invention concerns a device for the refrigerated storage and dispensation of samples, especially a sample dispenser used in chromatography. The device exhibits a receptacle for one or multiple samples, which is kept at a specific temperature in order to keep the samples at a constant temperature over a longer period of time and to keep the temperature-dependent properties of the sample substances constant independently of the time they are dispensed. Refrigeration at a constant temperature furthermore guarantees that the individual sample substances can be analyzed at the same temperature, making the results comparable. The invention also includes an integrated liquid cooling unit suitable for a device of this type for the refrigerated storage and dispensation of samples.

Especially High Performance Liquid Chromatography (HPLC) uses automated dispensers, whereby such dispensers may be filled with a large number of analysis samples, which may contain the same or different sample substances. At the requested time, these dispensers automatically forward the individual samples to the next processing step. The samples are located in suitable receptacles, which, on one hand, may consist of just the sample container and possibly holding fixtures for said samples, and on the other hand a so-called sample plate. The individual samples are drawn from the sample container by a sampling needle. The sample needle and the receptacle may be designed to be movable in relation to each other, allowing the targeted and individual drawing of each sample. Usually, the sample needle is movable along multiple travel axes in order to reach the desired sample. Another design uses a maneuverable, especially rotating or sliding sample plate. This simplifies the mechanisms required for the movement of the sampling needle since at least one travel axis can be implemented by the movement of the sample plate. This has also the advantage that the fluid lines to the sampling needle can be kept short.

Since the analyses under certain circumstances may take a very long time, and since furthermore the sample capacity in the sample dispensers is steadily increasing, the dwelling time of the individual samples to be stored in the dispenser for measurements also increases. For the aforementioned reasons and also due to the fact that many substances may change their composition at room temperature, the samples require refrigeration.

In one known method, the sample plate is kept a constant temperature by a Peltier cooling module, i.e. by a thermoelectric cooling device. In addition to the required, sufficient temperature stability, this type of dispenser must also provide an even temperature distribution throughout the sample receptacle in order to obtain comparable analysis results.

In the known sample dispensers with direct Peltier cooling, the sample plate is coupled via a heat-conducting metal element, which may also be part of the sample plate, to the cold side of the Peltier cooler. Attached to the warm side of the Peltier cooler is a heat sink. The heat emitted by the heat sink is discharged into an airflow, which may be provided by an additional fan.

In order to achieve a sufficient degree of efficiency, the heat transfer resistances between the Peltier cooling module and the sample plate and between the Peltier cooling module and the ambient air must be as small as possible. This requirement concludes that the most advantageous placement of the Peltier cooling module is directly underneath the sample plate to be cooled. The heat sink must therefore be attached to the underside of the Peltier module. In the case of a rotating sample plate, the Peltier module, including the heat sink, is rotating along with the sample plate.

This design is associated with the disadvantage that the entire cooling system must be installed underneath the sample plate, which requires the entire device to have a greater height. Another disadvantage is the fact that the heat dissipation at the warm side of the Peltier cooling module must take place in the immediate vicinity of the sample plate. This requires complex thermal insulation to prevent any feedback to the sample plate and the entire receptacle, including the samples contained therein, due to a rise in temperature caused by the heat discharged by the warm side of the Peltier module.

Also known in addition to the direct thermoelectric cooling of the sample receptacle is the use of air cooling. The air is brought to the desired temperature inside a cooling unit. A fan generates a sufficiently strong air stream, which is routed past the sample plate or the receptacle, thus cooling it accordingly. This cooling unit may have different designs, e.g. thermoelectric or based on evaporation.

Due to the low heat capacity of air, a sufficiently large volume flow is required to achieve a sufficient heat transfer. This requires air channels with large cross sections combined with an increased need for space and installation size. The low heat capacity of air as a cooling medium also makes it difficult to ensure a uniform temperature distribution.

The last known method for the cooling of a sample dispenser is an external refrigeration system. Known, for example, is the coupling of an external liquid cooling system in the form of a cryostat with a sample dispenser. The cryostat provides a cooling liquid that has been cooled to the desired temperature. An area below the sample plate is traversed by the cooling liquid and thus brought to the same temperature as the cooling liquid.

The special disadvantage of this solution is its need for large space due to the additional external unit. Also, in order to operate properly the cooling system must first be connected, filled and primed.

Since such known sample dispensers exhibit stationary sample plates it is also necessary to provide a more complex needle drive for the removal of samples with the accordingly long junction lines.

Another disadvantage is the fact that the temperature of the cooling liquid is regulated inside the external unit. This means that the temperature of the receptacle depends on other factors, e.g. the ambient temperature and air movement as well as the length of the lines for the cooling liquid.

This invention has therefore the objective to provide a device for the refrigerated storage and dispensing of sample substances, especially a sample dispenser for chromatography, whereby the aforementioned disadvantages of known systems shall be avoided, and the height of the unit shall be kept to a minimum. The invention has the additional objective to provide an integrated liquid cooling unit for such a device.

The invention meets this objective with the characteristics of patent claims 1 and 7.

The invention is based on the realization that the use of liquid cooling in a device for the refrigerated storage and dispensation of samples, for example a sample dispenser for chromatography, can easily be designed at a small size, especially a low height, if the liquid cooling unit is a Peltier module. Such Peltier cooling modules are suitably small and can be installed at any place inside the device for the refrigerated storage and dispensation of sample substances while a liquid cooling medium transfers the heat from the receptacle to the location of the liquid cooling unit.

By positioning the liquid cooling unit and especially the included Peltier cooling module at a distance from the receptacle we get the advantage that the heat energy to be discharged from the warm side of the Peltier cooling unit can be discharged without heating the receptacle.

In one embodiment of the invention the minimum of one hollow space traversed by the liquid cooling medium, which is present in at least one part of the receptacle, has the shape of a channel.

By routing the channel accordingly or using multiple channels with the same cross sections and the same flow resistance between flow and return, a uniform temperature of the receptacle, especially the sample plate, can be achieved.

For example, it is possible to design at least one channel in such fashion that its first section runs from its flow connection port to a point or area of reversal, and its second section runs from the point or area of reversal to its return connection port, whereby the first section essentially runs in its entire length in parallel to the second section. This guarantees that for an assumed uniform heat dissipation per unit of length in each longitudinal section of the dual channel, in which a part of the first section and a part of the second section of the (at least) one channel is located, essentially the same amount of heat can be absorbed.

The first and second section of the (at least) one channel may form a double helix or a dual-meander structure.

In another embodiment of the invention, a temperature sensor may be included, which monitors the actual temperature of the receptacle, preferably at a location near the sample substances. By adding a control unit, which receives the signal of the temperature sensor, the monitored actual temperature can be kept at a certain target value within preset tolerances by controlling the output of the pump and/or the output of the Peltier cooling module.

A suitable, integrated liquid cooling unit for such a device for the refrigerated storage and dispensation of samples includes a pump for the delivery of the liquid cooling medium from an intake port to an outlet port, exhibiting a pump housing, in which the intake port and the outlet port are located or to which the intake port or the outlet port are connected.

The wall of the pump housing is at least in one cooling area designed for a low heat transfer resistance. In this cooling area, at least one Peltier cooling module is connected to the pump housing with good heat conduction in order to affect the transport of heat energy from the cooling medium traversing the pump housing to a heat sink. The heat sink is connected directly to the warm side of the Peltier cooling unit. Located between the pump housing and the heat sink, outside the area in which the (at least) one Peltier cooling module is located between the outside wall of the pump housing and the wall of the heat sink facing the outside wall is some type of insulation. This largely prevents feedback from the warm side of the Peltier cooling module to its cold side and therefore to the pump housing, thereby increasing the overall efficiency.

The heat sink can be designed as a radiator with a surface-increasing structure.

The pump may be driven by an electric motor inside the unit, comprised of a heat sink, pump housing, Peltier cooling module and insulation, located preferably inside the volume of the heat sink. The result is an extremely small liquid cooling unit.

In this configuration, the pump drive is able to transfer its thermal dissipation loss directly to the heat sink, so that it is used for the dissipation of heat energy from the warm side of the Peltier cooling module as well as for the dissipation of the thermal power loss of the pump drive. This too, contributes to an extremely compact design of the liquid cooling unit.

Especially expedient is the implementation of the electric motor in the form of an electronically commutated motor with a permanent-magnet rotor. In this case, the rotor does not require any electrical energy, allowing it to be located directly inside the sealed pump housing. The electromagnetic rotating field required to drive the rotor can be realized by providing the necessary stator windings as well as an outer rotor, to which, in turn, permanent magnets are attached.

The provision of the permanent magnets inside the sealed pump housing results in the advantage that it is not necessary to include a drive shaft to extend out of the pump housing. Another advantage is the fact that a permanent-magnet rotor does not release any thermal loss; the radiator can be cooled by a fan also integrated into the liquid cooling unit.

The shaft of the electric motor for the pump drive may, of course, also extend out of the pump housing and be connected to the fan disk of the fan. In this case, the sealed pump drive shaft must pass through the pump housing but a separate fan motor is not required.

According to a different embodiment, a fan with a separate electric motor drive can, of course, also be used. This electric motor drive can simultaneously also be coupled with permanent magnets to drive an outer rotor in a rotational manner. The electromagnetic rotating field generated by the permanent magnets of the outer rotor can be used to drive a sealed rotor (without extended feed-through shaft).

According to the preferred embodiment of the invention, the pump itself is designed as a centrifugal pump with a pump impeller.

The pump impeller and the (at least) one Peltier cooling module may be configured in or at the pump is such fashion that the pump impeller effects the mixing of the cooling medium located inside the pump housing, which is contained in a volume adjacent to the cooling area of the pump housing.

This results in the advantage that otherwise required mixing elements for the swirling of the cooling medium, which would increase the flow resistance inside the pump housing, are not required anymore.

Additional embodiments result from the subclaims.

In the following, the invention is explained in greater detail using the embodiments represented in the drawings. The drawings show in:

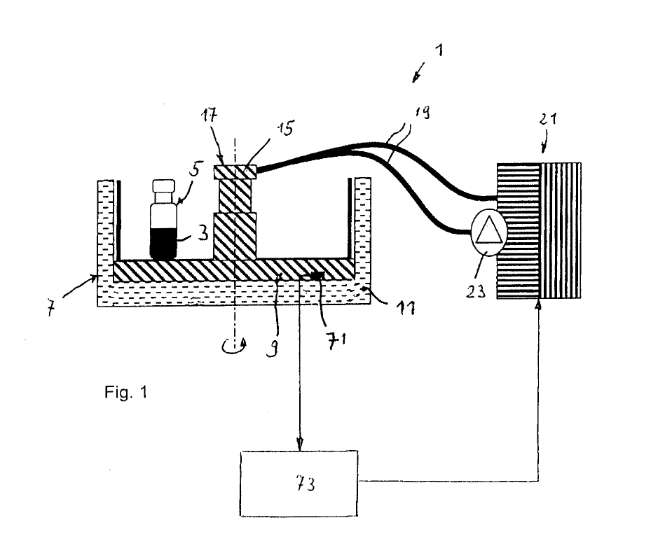

FIG. 1 a schematic view of the major components of a sample dispenser for chromatography with a receptacle for the sample substances and an integrated liquid cooling unit as described in the invention;

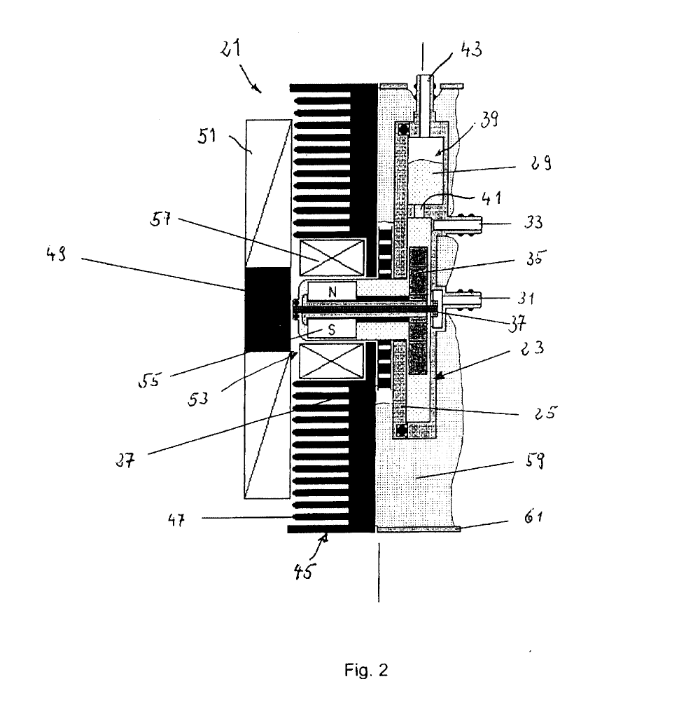

FIG. 2 a schematic cross-sectional view of the integrated liquid cooling unit in FIG. 1, and

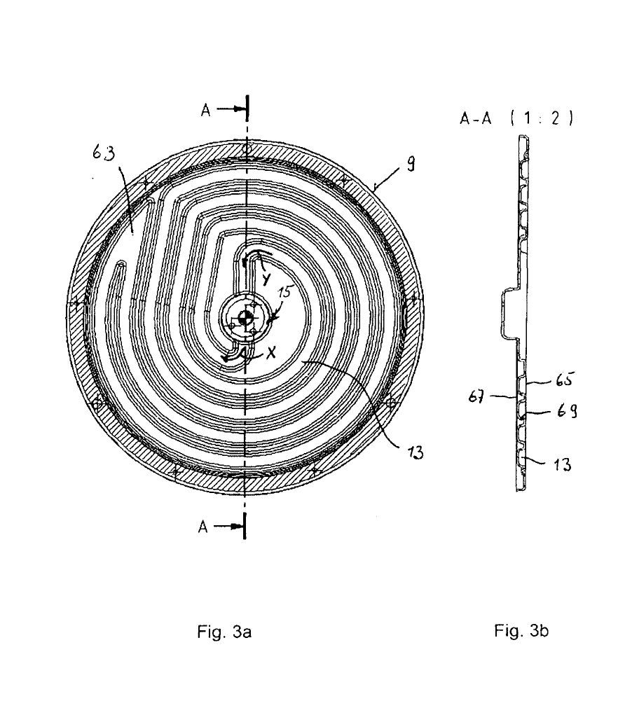

FIG. 3 a schematic top view of the receptacle in FIG. 1 with a spiral-shaped configuration of channels for the cooling medium (FIG. 3a) and a sectional view along the A-A line (FIG. 3b).

FIG. 1 shows a schematic view of a device 1 for the refrigerated storage and dispensation of samples 3, which may, for example, may be gathered in small containers 5. The containers 5 may, of course, also be located in cages (not shown).

Alternatively, the substances may also be placed directly in a receptacle with depressions. In the following description, any means to hold the actual sample substances 3 are called the receptacle 7. In the shown embodiment, the receptacle 7 includes the containers 5 and cup-shaped sample plate 9, which is insulated at the bottom and at the outer walls with a heat insulation 11. The heat insulation 11 is made of a sufficiently well heat-insulating material and exhibits a sufficient thickness.

Located at least at the bottom of the sample plate 9 is a hollow space, for example in the shape of channel 13 (FIG. 3) for the routing of a liquid cooling medium. The liquid cooling medium reaches the sample plate 9 via an appropriate rotational duct 15 (FIG. 3) in a coaxial stud 17 of the sample plate 9. Attached to the coaxial stud 17 and the rotational duct 15 each is a flow port and a return port, each of which is connected to the appropriate ends of the channel 13. The flow port and the return port each are connected by a connecting line 19 to the intake port and the outlet port of an integrated liquid cooling unit 21. The integrated liquid cooling unit 21 includes a pump 23 for the transport of the liquid cooling medium through the connecting lines 19 and the connected channel 13.

With the rotational duct 15 inside the coaxial stud 17 of the sample plate 9, the sample plate 9 can be propelled in rotational motion around its axis in order to move each container 5, from which a sample is to be taken, into the dispensing position. In doing so, the rotational duct 15 guarantees that a connection of the channel 13 with the flow port and the return port of the rotational duct 15 and all associated connecting lines 19 is maintained independently of the sample plate's angular position.

The spatial separation between the integrated liquid cooling unit 21 and the sample plate 9 and the receptacle 7 and the transport of heat via the liquid cooling medium from the receptacle 7 to the liquid cooling unit 21 leads to the advantage of a flexible configuration of the liquid cooling unit 21 within the joint body (not shown) of the device 1. In contrast to known sample plates 9 being cooled from the bottom directly via a Peltier cooling module this provides the advantage of a low installation height of such a device.

Furthermore, the spatial separation of the integrated liquid cooling unit 21 from the receptacle 7 achieves the advantage of low-level feedback of the heat dissipated by the liquid cooling unit 21 to the receptacle 7. In any case, even when the liquid cooling unit 21 is positioned directly next to the receptacle 7, an insulation can be used to avoid such feedback. In many cases such insulation is not required since the liquid cooling unit 21 can be positioned at a sufficient distance from the receptacle 7. For example, the warm side of the liquid cooling unit 21 can be positioned at the back or another outside wall of the housing of the device 1.

FIG. 2 shows a schematic cross section of the embodiment of an integrated liquid cooling unit 21. The liquid cooling unit 21 includes a pump 23, configured as a centrifugal pump. The pump housing 25 is comprised in at least one area, in which the pump housing 25 is connected to the cold side of a Peltier cooling module 17, of a good heat-conducting material, so that the heat transfer resistance for the heat transfer from the liquid cooling medium 29 located in the pump housing 25 to the cold side of the Peltier cooling unit 27 is sufficiently small.

The centrifugal pump exhibits at its pump housing 25 an intake port 31 and an outlet port 33. The intake port 31 and the outlet port 33 may be connected to the flow and return port of the receptacle 7 or the rotational duct 15 via connecting lines 90 (FIG. 1). Located inside the pump housing 25 is the fan disk 35 of the centrifugal pump 23. The fan disk can be rotated inside the pump housing 25 using a shaft 37. The pump housing 25 preferably seals the shaft and the required bearings so that no sealed feed-through of the shaft 37 from the pump housing 25 is required. Expensive, sealed rotational feed-throughs through the pump housing are therefore not required.

The impeller 35 is located in a volume inside the pump housing 25, which is located directly adjacent to the area in the body wall, through which the heat transport in the direction of the cold side of the Peltier cooling unit 27 takes place. This generates in the vicinity of this area of the body wall a turbulent flow, causing the cooling medium already cooled by the Peltier cooling module and the incoming, relatively warm cooling medium to be mixed well. This significantly improves the heat transfer from the Peltier cooling module and therefore the overall efficiency of the entire system.

The shaft 37 can preferably be made of a ceramic material to keep the wearing of the bearings in the pump housing to a minimum. The lower heat conductance in comparison to metallic materials prevents the introduction of heat energy into the inner area of the pump and the transfer of this heat into the liquid cooling medium 29.

As shown in FIG. 2, the pump housing 25 may also be designed with an integrated storage container 39 containing an additional cooling medium 29. The addition of the storage container 39 in the upper area causes the cooling medium stored in said container to be automatically added via the feed opening 41 into the circulating cooling medium.

The storage container 39 may be filled via a filling port 43. By filling the storage container 39 only partially with cooling medium, the remaining volume of the storage container 39 filled with air acts simultaneously as compensation reservoir for the thermal expansion of the cooling liquid, which is dependent on the operating status. If the overall temperature of the cooling medium is increased the cooling medium requires more volume, so that the liquid level in the storage container 39 rises and the air located above the liquid is being compressed.

The warm side of the Peltier cooling module 27 is directly connected to a radiator 45. This radiator may exhibit the usual cooling ribs 47 to increase the surface for the transfer of the discharged heat energy into the ambient air.

In order to improve the heat discharge from the radiator 45 a fan 49 may be installed at its exhaust side. The fan 49 includes preferably a stand-alone electric motor drive for the rotating drive of the fan disk 51.

The pump is driven by an electric motor drive 53, consisting of permanent magnets 55 on the shaft 37, which form the rotor of the electric motor drive 53 inside the pump housing 25, and stator coils 47, which generate the alternating electromagnetic field required for the rotor to move. The electric motor drive 53 is according to FIG. 2 preferably contained inside the volume of the radiator 45. The result is on one hand the advantage of a very compact design and on the other hand the advantage that the heat energy generated by the electromagnetic drive 53, especially by the stator coils 57, can also be directly discharged via the radiator 45.

Other types of electric drives for the centrifugal pump 23 are, of course, also conceivable. For example, in place of the stator coils 57 an outer rotor could be used, which can be rotated coaxially to the shaft 37. This outer rotor may include permanent magnets, whose rotation would generate the alternating field required to drive the pump-internal rotor with the permanent magnets 55. The outer rotor can be coupled to the electric motor drive of the fan 49, and may be driven by this drive.

According to another (not shown) embodiment of the invention, the pump shaft 37 can extend from the back of the radiator 45 and be coupled to the fan disk 51. In this way, a stand-alone electric drive for the fan 49 is not required.

Between the radiator 45 and the pump housing may be insulation material 59. The pump housing may, as shown in FIG. 2, may also be completely enclosed with insulation material 59, i.e. with the exception of the area, in which the pump housing is connected to the cold side of the Peltier cooling module 27. The insulation material 59 may, of course, also be enclosed by an outer wall of an insulation housing 61, protecting the insulation material 59 against external environmental influences. Extending from the insulation housing are in this case only the intake port 31, the outlet port 33 and potentially the filling port 43.

The integrated liquid cooling unit shown in FIG. 2 therefore reflects an extremely compact design, allowing the use of scaled down devices for the refrigerated storage and dispensation of sample substances.

FIG. 3a shows a schematic sectional view of a horizontal section of the bottom of the sample plate 9 from FIG. 1. The horizontal cross section in FIG. 3a and the sectional view in FIG. 3b indicate clearly that the sample plate 9 exhibits in its bottom a channel 13 for the liquid cooling medium, which essentially has the form of double helix. Coming from the rotational duct 15, the cooling medium moves in the direction of the arrow X from a flow port into the channel 13 and flows in the form a spiral to the point or the area of return 63 of the channel 13.

After the area of return 63, the cooling medium essentially flows in parallel to the first section of channel 13 between the flow port and the area of reversal 63 back to the return port of the rotational duct 15 (direction of arrow Y in FIG. 3a). Since the first section of the channel 13 and the second section of channel 13 between the area of reversal 63 and the return port are running parallel, an exceptionally even temperature distribution across the bottom of the sample container 19 is being achieved.

As shown in FIG. 3b, the channel 13 can be realized by, for example, installing a channel element 69 between a lower wall 65 and an upper wall 67 of the bottom of the sample plate 9, whereby the channel 13 is created by the combined effect of the inner walls of the channel element 69 and the lower or upper wall 65, 67. The channel element 69 may be made by embossing the double-helix structure into a flat element like sheet metal or such.

The double-helix structure may, of course, be replaced by any other structure provided that a first channel section from a flow port to a point of reversal and a second channel section from the point of reversal to a return port are essentially running in parallel.

In order to be able to maintain a constant temperature of the receptacle 7 within tight limits, a temperature sensor 71 may be installed at the receptacle, especially at or inside the bottom of the sample plate 9, whose temperature signal will be forwarded to a control unit 73. The controller 73 can then regulate the liquid cooling unit 21, especially the output of the pump 23 and the output of the Peltier cooling module 27 in such manner that the temperature at the receptacle 7 is regulated to a constant target value.

1-18. (canceled)

19. Integrated liquid cooling unit for a device for the refrigerated storage and dispensation of sample substances, especially for a sample dispenser used in chromatography,
a) with a pump for the transportation of the liquid cooling medium from an intake port to an outlet port exhibiting a pump housing, in which the intake port and the outlet port are located or to which the intake port and the outlet port are connected,
b) wherein the wall of the pump housing exhibits in at least ones cooling area a low thermal transfer resistance,
c) with at least one Peltier cooling module with its cold side directly installed at the cooling area of the pump housing for the transportation of thermal energy of the cooling medium traversing the pump housing to a heat sink,
d) wherein the heat sink is connected directly to the warm side of the Peltier cooling module,
e) exhibiting between the pump housing and lie heat silk outside the area, in which the at least one Peltier cooling module is installed, a type of insulation,
f) wherein the pump is designed as a centrifugal pump, and
g) wherein the impeller of the rotating pump and the at least one Peltier cooling module are configured in such fashion that inside the pump housing the pump impeller stirs the cooling medium, which is contained in a volume adjacent to the cooling area of the pump housing.

20. Liquid cooling unit according claim 19, wherein the heat sink is configured in the form of a radiator.

21. Liquid cooling unit according to claim 19, wherein the pump is driven by an electric motor, which is located inside the unit consisting of the heat sink, the pump housing. the Peltier cooling module and a type of insulation, inside the heat sink volume.

22. Liquid cooling unit according to claim 19, wherein the pump is driven by an electric motor, which is located inside the unit consisting of the heat sink, the pump housing, the Peltier cooling module and a type of insulation, inside the heat sink volume.

23. Liquid cooling unit according to claim 21, wherein the pump drive discharges its thermal power loss directly into the heat sink.

24. Liquid cooling unit according to claim 21, wherein the electric motor exhibits a permanent-magnet rotor, wherein the permanent-magnet rotor is installed inside the sealed pump housing.

25. Liquid cooling unit according to claim 23, wherein the electric motor exhibits a permanent-magnet rotor, wherein the permanent-magnet rotor is installed inside the sealed pump housing.

26. Liquid cooling unit according to one of claim 20, wherein the radiator is being cooled by a fan, and whereby the fan is integrated into the liquid cooling unit.

27. Liquid cooling unit according to one of claim 21, wherein die radiator is being cooled by a fan, and whereby the fan is integrated into the liquid cooling unit.

28. Liquid cooling unit according to one of claim 23, wherein the radiator is being cooled by a fan, and whereby the fall is integrated into the liquid cooling unit.

29. Liquid cooling unit according to one of claim 24, wherein the radiator is being cooled by a fan, and whereby the fan is integrated into the liquid cooling unit.

30. Liquid cooling unit according to claim 26, wherein td e shall of the electric motor is connected to the pump as well as to the fan disk.

31. Liquid cooling unit according to claim 26, wherein the fan exhibits a separate electromotive drive.

32. Liquid cooling unit according to claims 24 and 31, wherein the electromotive drive of the fan is driven by rotation and coupled to a permanent-magnet, which generates a rotating magnetic field to drive the rotor installed inside the sealed pump housing.

33. Liquid cooling unit according to claim 19, wherein such unit exhibits a reservoir for the cooling medium, which is either connected to the pump housing or integrated into it.

34. Liquid cooling unit according to claim 19, wherein the entire cold section of the liquid cooling unit consisting of the pump housing and, if present, the reservoir is essentially enclosed by a type of insulation material.
